(19) United States
(12) Patent Application Publication
(10) Pub. No.: US 2008/0248365 A1
(43) Pub. Date: Oct. 9, 2008

(54) Flow Control Apparatus and Method for Fuel Cell Flow Fields

(75) Inventors: David P. Wilkinson, North Vancouver (CA); Roya Rahbarl, Vancouver (CA); Joerg Zimmerman, Vancouver (CA); Mauricio Blanco, Vancouver (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, CA

(73) Assignee: National Research Council od Canada

(21) Appl. No.: 11/629,098

(22) PCT Filed: Jun. 10, 2005
(86) PCT No.: PCT/CA05/00913

§ 371 Date: Oct. 25, 2007

Related U.S. Application Data
(60) Provisional application No. 60/578,287, filed on Jun. 10, 2004.

(51) Int. Cl. H01M 8/04; G05D 7/00

(52) U.S. Cl. 429/34; 429/14

(57) ABSTRACT

An adjustable flow field and flow regulation method for an electrochemical device such as field preferably includes a plurality of flow paths between an inlet and an outlet and a plurality of microvalves for regulating fluid flow through the flow paths in response to changes in the operating states of the fuel cell, such as changes in power output or temperature. For example, adjustment of the microvalves may restrict the number of flow paths through which fluid is flowing to alter the effective active area and current density of the flow field. The valves may be selectively opened or closed, either entirely or partially, to maintain a minimum pressure drop between the inlet and outlet. Alternatively or additionally, adjustment of the valves may alter the direction of fluid flow through at least some of the flow paths. The invention improves the stability of the fuel cell in low power and low reactant stoichiometry operating states without significantly increasing the complexity of the system or increasing parasitic loads. For example, the invention may improve water management in low power modes and avoid related performance problems such as low current density failures and voltage oscillations. The invention may also help reduce the cost and complexity of the system power electronics.

### REFERENCE TO RELATED APPLICATION

This application claims priority from U.S. provisional patent application No. 60/578,287 filed 10 Jun. 2004 which is hereby incorporated by reference.

### TECHNICAL FIELD

This invention relates to the fuel cell flow fields and regulation of fluid distribution in fuel cells.

### BACKGROUND

Fuel cells are electrochemical devices that convert chemical energy in the form of fuel and oxidant into electrical energy. Many fuel cell designs include fluid distribution plates to supply and distribute fuel to the anode and oxidant to the cathode. Such plates perform several functions including acting as current collectors, providing mechanical support for the electrodes, providing access channels for delivering reactants to their respective electrode surfaces and for removing product water or other reaction byproducts such as carbon dioxide, and to prevent mixing of oxidant, fuel and coolant liquids.

Generally, fuel cell stacks have a manifolded reactant feed to individual cells. In order for the fuel cell to function optimally, it is very important that all of the cells receive the same reactant flow and have similar performance. Flow fields are the channels formed in the fluid distribution plates which function as conduits for the fluid reactants and reaction products.

Conventional fuel cell flow fields have fixed channel geometries that determine the reactant flow characteristics over the operational range of the fuel cell. Flow fields are normally designed around their maximum power operating point and the pressure drop (e.g. between the flow field inlet and output) is typically minimized at this point. Flow rate and pressure drop are a parasitic load on the overall power generation system and designers commonly try to minimize them. However, while a flow field design may be optimally designed at maximum power, it is often a poor design for operation at the low power end of the operational range. Depending upon the application, power requirements and corresponding reactant flow rates can fluctuate widely. For example, in the case of an automobile, power requirements and reactant flow rates can change by over two orders of magnitude: a fuel cell stack may operate at 300 A at peak power but only 3 A at low power. The flow field usually gives good Water management at peak power (the optimal design point) but poor water management at low power. That is, there may be insufficient pressure drop at low power to prevent accumulation of reaction byproducts such as liquid water in flow field channels. This may in turn result in voltage oscillations and other performance problems.

To overcome the problems associated with low power operation, various approaches are known in the prior art including imposing a larger pressure drop and/or periodically purging the flow field with a high velocity gas flow to evaporate liquid water or to cause the water to become entrained in the gas stream. However, such approaches also increase system complexity and parasitic load which is inefficient and undesirable.

Some inventions are known in the prior art which regulate the flow of reactants depending upon the operating state of the fuel cell or other power generating device. For example, United States Patent Publication US 2004/0224206, Matsumoto et al., published 11 Nov. 2004, relates to a polymer electrolyte fuel cell which is configured so that the cells operate in parallel at high power loads and in series at low power modes. Operating the cells in series at the low power loading allows high gas flows, thereby minimizing water condensation and improving the stability and performance of the fuel cell stack. In particular, the stack includes various valves linked to the inlet and outlet manifolds and a controller which opens and closes selected valves in response to a power mode of the fuel cell stack. However, in Matsumoto et al. the valves are located at the level of the manifolds rather than in the flow fields of the fuel cells themselves.

U.S. Pat. No. 6,503,651 B1, Nguyen, issued 7 Jan. 2003, also exemplifies the prior art. Nguyen relates to methodology and apparatus for supply of reactant fluids to and purging of product and inert fluid from cells of a fuel cell stack. The apparatus includes micro-electromechanical (MEM) valving which is operable to selectively open fuel cell product outlets to achieve optimum system purging. However, the Nguyen valves do not regulate fluid flow within the fuel cell flow fields themselves.

Vipperman et al. have described piezoelectrically actuated microvalves for flow control in PEM fuel cells (Proceeding of IMECE-02, 2002 ASME International Mechanical Engineering Congress and Exposition, pp. 497-505, 17 Nov. 2002). Vipperman describes using such valves to improve flow maldistribution problems rather than to alter the active flow areas of a flow field in response to changes in fuel cell power demands or other changes in fuel cell operating states.

The need has therefore arisen for adjustable fuel cell flow fields for improving fuel cell performance, particularly in low power modes, without significant system complexity or parasitic load.

### SUMMARY OF INVENTION

In accordance with the invention a flow field for an apparatus operable in variable operating states is provided. The flow field may include at least one inlet for delivering fluid to the flow field; at least one outlet for discharging fluid from the flow field; at least one flow path between the inlet and the outlet; and at least one adjustable valve for selectively regulating fluid flow through the flow path in response to changes in the operating states of the apparatus.

In one embodiment the apparatus is an electrochemical device such as fuel cell and the flow field may comprise a plurality of flow paths between the inlet and the outlet and a plurality of valves for regulating fluid flow through at least some of the flow paths. For example, adjustment of the valves may restrict the number of flow paths through which fluid is flowing to alter the effective active area and current density of the flow field. For example, the valves may be selectively opened or closed to maintain a minimum pressure drop between the inlet and outlet. Alternatively or additionally, adjustment of the valves may alter the direction of fluid flow through at least some of the flow paths.

The invention may also relate to a method for regulating the flow of fluid in a flow field as described above when used in conjunction with an apparatus operable in variable operating states. The method may include monitoring changes in the operating states of the apparatus and selectively regulating the flow of fluid through the flow paths in response to changes in the operating states.

Fuel cell stacks and fuel cell flow field assemblies comprising a plurality of adjustable flow fields as described above are also within the scope of the invention.

### BRIEF DESCRIPTION OF DRAWINGS

In drawings which illustrate non-limiting embodiments of the invention:

FIG. 1 is a schematic view of flow field in accordance with one embodiment of the invention having an interdigitated architecture and a plurality of flow control microvalves.

FIG. 2 is a schematic view of flow field in accordance with an alternative embodiment of the invention having a serpentine architecture and a plurality of flow control microvalves.

FIG. 3 is a graph showing the relationship between voltage, current, reactant flow and pressure drop in a fuel cell running with constant reactant stoichiometry.

FIG. 4 is a schematic view of a flow field in accordance with an alternative embodiment of the invention having a plurality of microvalves arranged in series to regulate a pressure drop in a stepwise manner.

FIG. 5 is a schematic view of a further alternative embodiment of the invention wherein the microvalves are adjustable to control the direction of fluid flow through the flow field, for example to switch between parallel flow and serpentine flow.

FIG. 6 is a schematic view of a cathode plate having a flow field configured in accordance with the invention.

FIG. 7 is a photograph of an interdigitated cathode plate illustrating a prototype of the invention.

FIG. 8 is a photograph of a fuel cell system employing having a cathode plate as illustrated in FIG. 7.

FIG. 9 is a graph showing a polarization curve and pressure drop curve for a cathode plate having a flow field in accordance with the invention with all valves open.

FIG. 10 is a graph showing voltage versus current density in the case of (a) all valves of the flow field open; and (b) four valves closed.

FIG. 11 is a graph showing voltage versus current in the case of (a) all valves of the flow field open; and (b) four valves closed.

FIG. 12 is a voltage trace for decreasing stoichiometry in the case of all valves open. In this case the fuel cell was operating under a load of 100 mA/cm².

FIG. 13 is a voltage trace showing recovery of unstable performance in a fuel cell having a reduced active area (four out of six flow field valves closed). In this case the fuel cell was initially operating under a load of 80 mA/cm². When four of the valves were closed the current density increased to 254 mA/cm².

FIG. 14 is a schematic view of a cathode plate having a flow field having serpentine flow paths and multiple external valves.

FIG. 15 is a schematic view similar to FIG. 14 showing a cathode plate having a flow field with serpentine flow paths and multiple microvalves located within the plate.

FIG. 16 is a schematic view showing a cathode plate having a flow field with interdigitated flow paths and microvalves.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

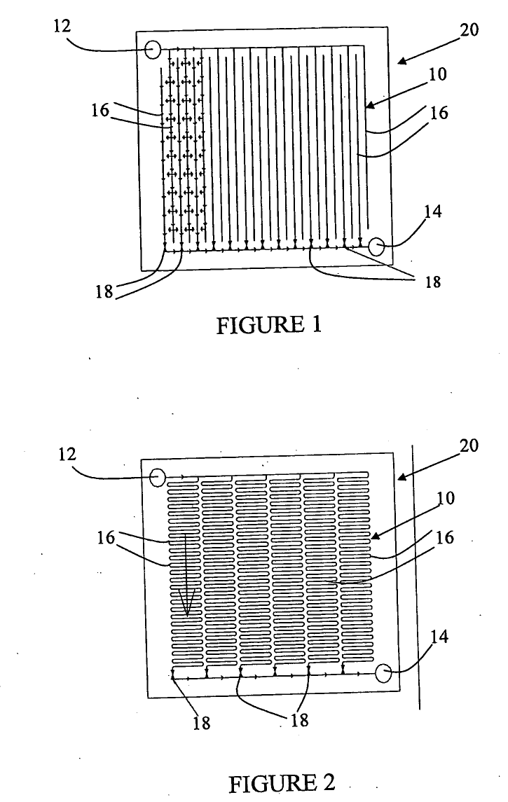

As shown schematically in FIG. 1, this application relates to a flow field 10 for use in distributing fluid to a fluid processing apparatus. Throughout this application, the invention is described for use in conjunction with a fuel cell. However, as will be appreciated by a person skilled in the art, the invention could be employed to adjustably distribute fluid to other types of apparatuses including other types of electrochemical devices.

In the case of a fuel cell, flow field 10 delivers fluid reactants to the fuel cell and discharges fluid reaction products from the fuel cell. For example, separate flow fields 10 may be used to deliver fuel to the anode and oxidant to the cathode. Flow fields 10 may also be used to remove reaction products such as water.

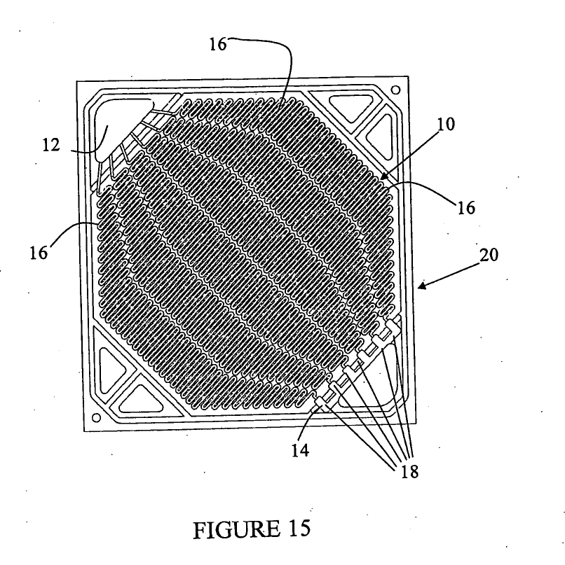

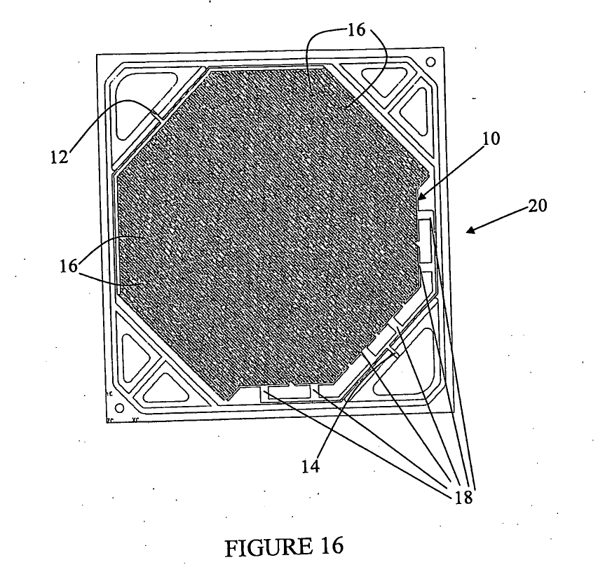

As shown in FIGS. 1, 2, 4, 5, and 15-16 flow field 10 may be configured in different flow path geometries. With reference to FIG. 1, flow field 10 includes an inlet 12, an outlet 14, and a plurality of separate flow paths or channels 16 between inlet 12 and outlet 14. Typically inlet 12 is in fluid communication with a reactant inlet manifold and outlet 14 is in fluid communication with a reaction product outlet manifold. A plurality of valves 18 regulate flow of fluid through flow paths 16. For example, each valve 18 may regulate fluid flow through a particular flow path 16 or a group of flow paths 16. As shown in FIGS. 1 and 2, valves 18 may be microvalves located within flow field 10. FIGS. 6 and 14 illustrate alternative embodiments where valves 18 may be located externally of flow field 10.

Fuel cell flow field 10 may be formed on a fuel cell plate 20. Plate 20 may additionally function as a current collector and a mechanical support for the fuel cell electrodes.

As will be appreciated by a person skilled in the art, various different types of valves 18 may be employed including piezoelectric microvalves, shape memory alloys and passive conductive polymer embodiments. As described further below, valves 18 may be configured to open and close (either entirely or partially) to regulate flow of fluid through an associated flow path 16 in response to external control signal(s) or some other parameter. As used in this patent application, the term “valve” includes any actuator for adjustably regulating fluid flow in a flow path 16.

Flow paths 16 may be deployed in various architectures. In FIG. 1 an interdigitated architecture is illustrated. In this case fluid may diffuse from one flow path 16 through a gas diffusion layer (GDL) into another flow path 16. In this embodiment valves 18 are located proximate the outlet end of alternating flow paths 16.

FIG. 2 illustrates an alternative embodiment of the invention having a serpentine architecture. Once again valves 18 are located proximate the outlet end of each flow path 16.

FIG. 4 illustrates a further alternative embodiment of the invention having a single serpentine flow path 16. In this embodiment, valves 18 are spaced between inlet 12 and outlet 14 in series to decrease the pressure and regulate flow of fluid through flow path 16 in a step-wise manner.

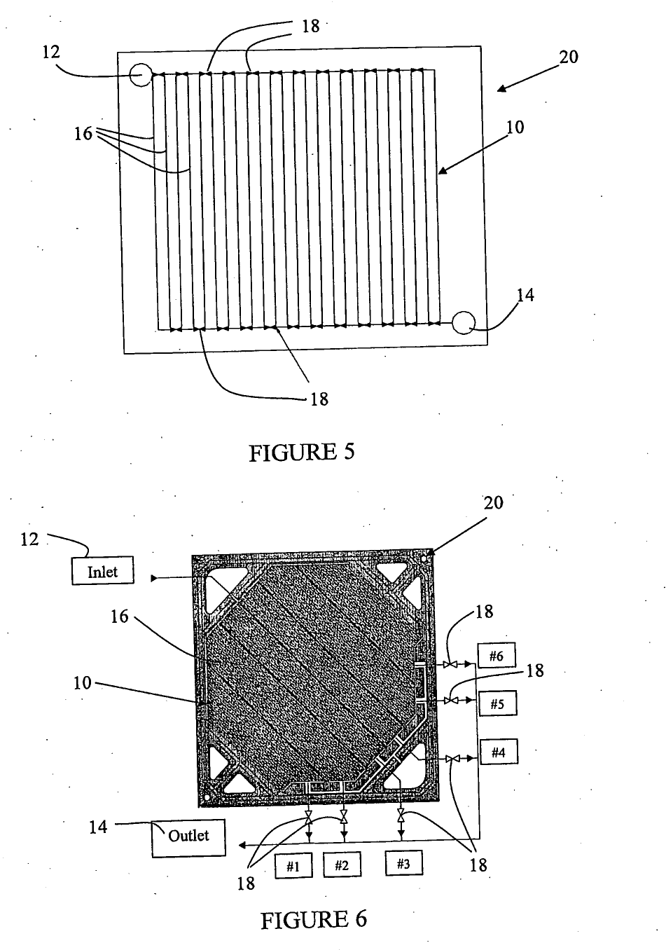

FIG. 5 illustrates a still further embodiment where flow field 10 is adjustable between either a parallel architecture or a serpentine architecture by opening an closing selected valves 18. In this embodiment some valves 18 are located proximate the inlet end of each flow path 16 and some valves 18 are located proximate the outlet end of each flow path 16.

As will be appreciated by a person skilled in the art, many other flow path configurations could be envisioned including straight or branched flow directions. In one embodiment, the volume of flow path 16 could vary on opposite sides of valve 18 (i.e. the dimensions of a particular flow path 16 could vary between inlet 12 and outlet 14). Flow paths 16 could also be configured to achieve three dimensional flow instead of, or in addition to, planar or two dimensional flow. In this example, flow paths or channels could also be formed in the gas diffusion layer (GDL) to enable three dimensional flow. Further, each flow field 10 may comprise a combination of two or more different flow architectures in different regions of the flow field 10 (or the GDL in the case of the example above).

Flow fields 10 are typically configured to maintain a pressure drop between inlet 12 and outlet 14. The quantum of the pressure drop may depend on various factors include the volume and flow rate of fluid reactant provided to inlet 12 from the reactant supply. The pressure drop for a continuous straight channel flow field can be calculated using Darcy's law as follows:

$$Δ P = \frac{fL ρ {V}^{2}}{2 {D}_{H}} \qquad ( 1 )$$

where f is the friction factor, V is the average flow velocity, D_{H} is the hydraulic diameter, L is the channel length, and ρ is the fluid density. The hydraulic diameter is related to the channel's (i.e. flow path 16's) cross-sectional area and perimeter (4A/p). The friction factor can be considered to be a combination of laminar and turbulent terms given by

$$f = {f}_{laminar} + {f}_{turbulent} = \frac{64}{Re} + {f}_{turbulent} = \frac{64 μ}{ρ {VD}_{H}} + {f}_{turbulent} \qquad ( 2 )$$

where Re is the Reynold's number and μ is the fluid viscosity. Substitution of this expression into Darcy's law gives the following overall expression for pressure drop in the flow field path 16:

$$Δ P = \frac{32 μ LV}{{D}_{H}^{2}} + \frac{{f}_{turbulent} L ρ {V}^{2}}{2 {D}_{H}} \qquad ( 3 )$$

The flow velocity V is related to the reactant stoichiometry by

$$\begin{matrix}{V}_{air} \approx \frac{60 ( 22.4 ) {λ}_{air} iA}{( 0.21 ) 4 F} \approx 0.0166 {λ}_{air} iA in slpm & ( 4 a ) \\ {V}_{hyd .} \approx \frac{60 ( 22.4 ) {λ}_{hyd .} iA}{2 F} \approx 0.0070 {λ}_{hyd .} iA in slpm & ( 4 b )\end{matrix}$$

where λ is the stoichiometry (inverse of utilization) of the respective reactant, i is the current density, A is the cell active area, and F is Faraday's constant.

For an interdigitated flow field architecture the pressure drop cannot be calculated only with equation (3) since there is an additional pressure drop caused by the diffusion of the reactant gas through the GDL from one flow path 16 to another as described above. The total pressure drop would be given by the sum of each pressure drop,

ΔPₜₒₜₐₗ=ΔPᵢₙₗₑₜ+ΔPₒᵤₜₗₑₜ+ΔP_{Diffusion} (5)

where ΔPᵢₙₗₑₜ is the pressure drop at the inlet, ΔPₒᵤₜₗₑₜ is the pressure drop at the outlet and ΔP_{Diffusion} is the diffusion pressure drop (5) which is given by

$$Δ {P}_{Diffusion} = - \frac{VL μ}{k} \qquad ( 6 )$$

where V is the superficial velocity, L is the channel's length, μ is the viscosity and k is the permeability of the media (units of m²).

As described below, when a fuel cell is operating in a low power state the volume of reactant fluid supplied to inlet 12 also commonly declines. This and other factors can result in a decline in pressure drop between inlet 12 and outlet 14. As explained above, this may cause undesirable consequences, such as the accumulation of water liquid in some flow paths 16. The prior art has attempted to address these problems by increasing the flow rate of reactant or imposing periodic systemic gas purges. Such processes increase system complexity and the higher pressure differentials must be balanced against larger parasitic energy demands. The associated parasitic load or energy required for gas delivery is directly related to pressure, volume flow rate, and pressure drop. The power necessary to adiabatically (no heat enters or leaves system) compress the reactant stream is given by

$$Power = η ( \frac{α}{( α - 1 )} ) {P}_{i n} {V}_{i n} ( {( \frac{{P}_{out}}{{P}_{i n}} )}^{( \frac{( α - 1 )}{α} )} - 1 ) C \qquad ( 7 )$$

where Pᵢₙ and Pₒᵤₜ are the absolute inlet and outlet pressures, Vᵢₙ is the inlet flow rate, α is the compressor efficiency, a is the isentropic exponent for each type of gas and C is a constant depending on the units used for pressure and inlet flow rate.

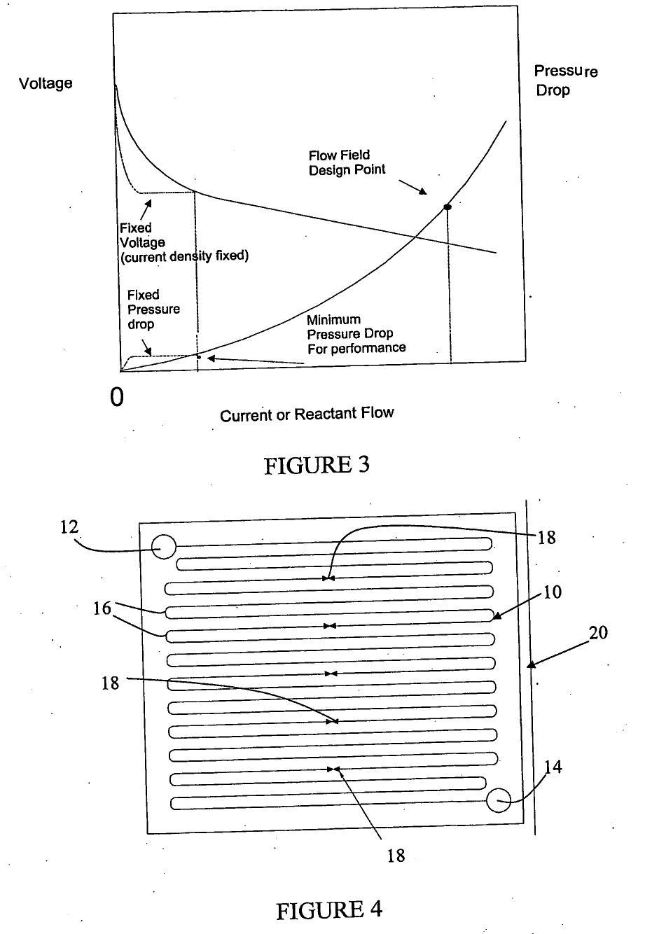

The present invention overcomes problems associated with low pressure drop and poor water management at lower power operating states in a different and more efficient manner. A fuel cell operating with constant reactant stoichiometry has well defined voltage and pressure drop relationships with current, as shown in FIG. 3. As explained above, when the load demands on the fuel cell decline the current produced by the fuel cell declines accordingly. This in turn results in a decline in reactant flow and a reduction in the pressure across flow field 10 between inlet 12 and outlet 14. In the present invention flow field 10 can react accordingly by regulating the flow characteristics of flow paths 16. For example, by adjusting selected valves 18 the effective active area and the current density of flow field 10 may be varied. That is, if selected valves 18 are closed, this can cause fluid to flow through only some of flow paths 16 and active flow regions may be isolated from non-active flow regions. Flow field 10 could be configured to ensure that gas shorting does not occur around the portion of the flow path 16 that is blocked.

By decreasing the flow field area at lower power operating states, the pressure drop can be decreased to improve water management (i.e. by removing liquid water reaction product accumulation) and enhance performance stability. In one embodiment of the invention a flow field 10 having a constant pressure drop could be achieved by selectively adjusting valves 18 as the operating conditions of the fuel cell change. In this case, since the pressure drop would with power fluctuations and reactant flow rate changes, optimal performance could be achieved over the complete operating range of the fuel cell. The pressure drop could be measured between inlet 12 and outlet 14 or across any particular region of flow field 10.

FIG. 3 shows a further additional benefit of the invention. By reducing the effective active area of the flow field 10 as described above, the current density (i.e. current per unit area) increases. This in turn reduces the voltage of the fuel cell. Since the voltage is increased in the low power range (FIG. 3), the overall range of voltage of the fuel cell over its operating range is narrowed. Reducing high voltages and voltage spike helps avoid corrosion and other fuel cell component degradation. This narrower voltage range also makes the design of the system power electronics much simpler. Further, an additional advantage of the present invention is that flow field 10 and the membrane electrode assembly of the fuel cell could be optimized for a smaller range of current density and flow rate.

As explained above, valves 18 could be actuated using several actuator technologies that are well suited to micro-fabrication such as shape memory alloy, electro-active polymer, passive conductive polymer or piezoelectric actuators. For example, valves 18 could be controlled by a logic circuit coupled to a voltage, current or temperature detectors measuring fuel cell operating state(s). Changes in other operating parameters could also or alternatively be monitored, such as other parameter(s) related to the power output of the fuel cell. In one example, valves 18 could be actuators responsive to a particular chemical, such as carbon monoxide. In other embodiments valves 18 could also be controlled passively rather than by an external trigger. For example, a conductive polymer valve 18 could be passively actuated by changes in fuel cell voltage.

While the above embodiments focus on controlling the active area of flow field 10 to maintain a threshold pressure drop and/or increase current density, selective adjustment of valves 18 could be used in numerous other ways. For example, valves 18 could be used in a proportional manner such that, in addition to controlling the active area, the valves would also throttle gas flows in the particular cell with respect to other cells in the stack. This could be used to balance the reactant flow distribution within the stack, and create an even cell-to-cell voltage distribution by ensuring that the low performing cell(s) get higher reactant flows. Microvalves 18 placed in the manifold(s) of the stack could also have this effect. Another approach could be to shut down portions of the manifold thereby increasing flow to the cells in the remaining part of the manifold. This would likely require current collecting plates at positions corresponding to the end cell of the active portion of the manifold.

The microvalves 18 could also be arranged in series along a flow field path 16 to decrease the pressure in a stepwise manner (FIG. 4). This could be advantageous because it would allow more water to be removed in the vapour phase. Instead of isolating areas of the fuel cell, the microvalves 18 could also be arranged such that they can change the flow field characteristics to suit the flow conditions. For example the flow field 10 could be changed from parallel or interdigitated flow for high flow rates to serpentine or cascaded serpentine flow at low flow rates (FIG. 5). Further, different regions of flow field 10 could react differently in response to changes in fuel cell operating states. For example, one region of flow field 10 could switch from parallel to serpentine flow whereas another region of flow field 10 could switch from interdigitated to branched flow. Many different flow variations are possible without departing from the invention.

As indicated above, the present invention could be used even for non-electrochemical devices where it is necessary to control the distributed flow of a fluid through a device. The same principles would apply except that the valves 18 could be activated by an external rather than an internal voltage signal.

### EXAMPLE

The following example will further illustrate the invention in greater detail although it will be appreciated that the invention is not limited to the specific example.

A modified Ballard® Mark V single cell was used with a Ballard 1 kW designed test station. The cell design used internal humidification and was operated with a constant coolant flow rate. The anode flow field plate was a standard 2 pass serpentine flow field but the cathode flow field plate was modified as described below. The membrane electrode assembly (MEA) consisted of a Nafion® 115 membrane, a total Pt catalyst loading of 1.0 mg/cm² with Toray TGP 090 gas diffusion layers. The MEA was conditioned prior to each test by running the cell at 800 mA/cm² until the cell voltage was stable. Cell temperature was characterized by the temperature of the oxidant out stream which is also equivalent to the coolant out temperature. The test station provided accurate control of the reactant pressures and gas flow rates, and regulated the flow of the humidification water and the coolant/heating water to the cell.

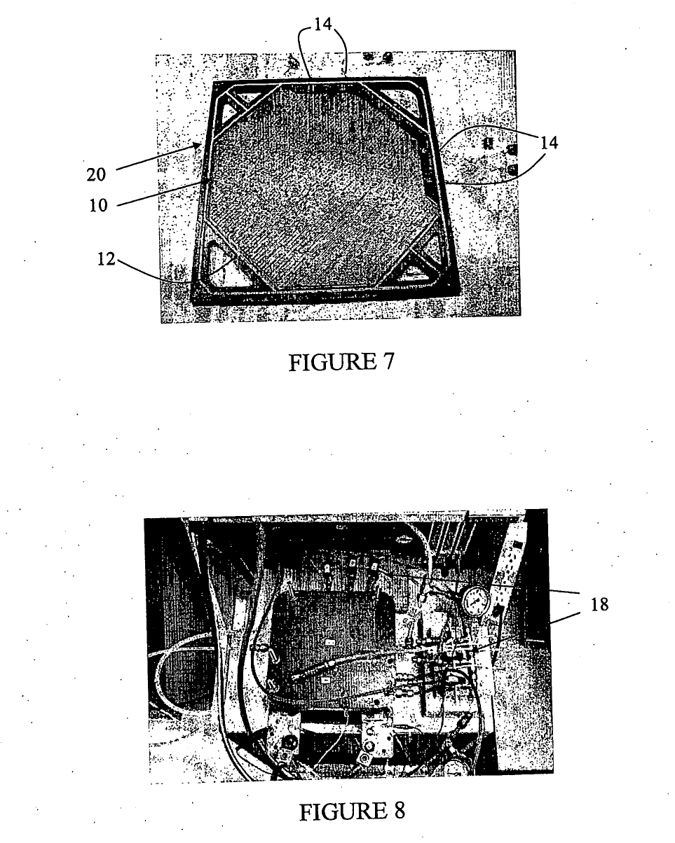

In order to change the active area of the cathode plate, a special interdigitated cathode flow field (260 cm² active area) was used as shown in FIGS. 6 and 7. The active area of the cathode plate was divided into six separate sections. FIG. 6 shows a schematic of the plate with tubing and valves. The sections corresponding to the valves #1 and #6 each have an area of ˜38.50 cm², the area for each of the sections controlled by the valves #2 and #5 is ˜52.15 cm² and finally, the last two sections (valves #3 and #4) each have an area of ˜39.35 cm². In this example, each section was connected to a valve (closed or opened manually) at the exit of the flow field located outside of the fuel cell. Thus, if a valve was closed the corresponding area in the flow field was also closed forcing the reactant flow to go to the other sections of the cathode by convection. FIGS. 7 and 8 are photographs of the plate and experimental set up, respectively.

The fuel cell testing was carried out at 75° C., the pressure for both reactant gases was 2 atm abs (29.4 psi), the hydrogen stoichiometry was kept constant at 1.5 and the air stoichiometry was varied in the experiments. The experimental test procedure was to decrease the air stoichiometry (based on the total active area) at low power (50 to 100 mA/cm²).with different active area sections available. The stoichiometry was varied from 2.0 to a lower stoichiometry where there was significant performance loss and voltage instability. At this point active area sections were shut down until performance and voltage stability were recovered.

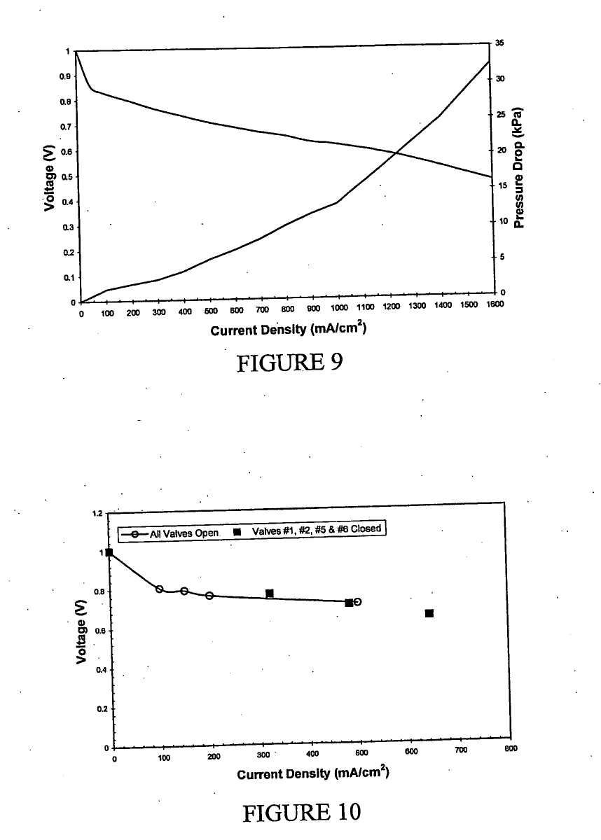

FIG. 9 shows the polarization curve (based on current density) and associated pressure drop curve for the interdigitated cathode flow field plate. For a typical minimum voltage efficiency design point of 0.6V the current density is approximately 1130 mA/cm², the areal power is 0.68 W/cm², and the pressure drop is 17.1 kPa (2.48 psi). However, at low power (e.g., 0.083 W/cm² at 100 mA/cm²) the pressure drop is 1.6 kPa (0.23 psi), about an order of magnitude lower. At this low power end there is insufficient flow and pressure drop to remove liquid water and to effect uniform reactant flow from cell to cell, and over the cell active area. System approaches to this issue rely on increased reactant flow rate and/or periodic purges.

FIG. 10 shows that cell performance is similar on a current density basis for the full active area (all valves open) and for the partial active area (4 valves closed). The cell was operated at a λₐᵢᵣ=1.5 and at a λ_{hyd*}=1.5. In this case the combined cell area of sections #3 and #4 (total area 78.7 cm²) gives similar polarization results to the full active area of 260 cm². This indicates that each section of the cell is performing similarly which is important in any approach that changes the active area.

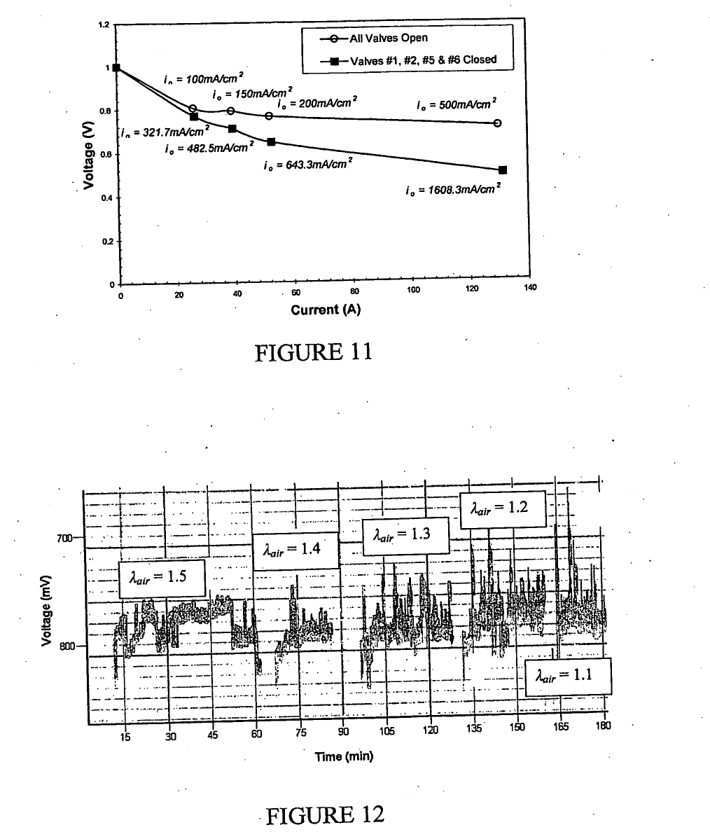

FIG. 11 compares polarization curves on an absolute current basis for the full active area (all valves open) and for a partial active area (4 valves closed). The cell was operated at a λₐᵢᵣ=1.5 and at a λ_{hyd*}=1.5. In the case of the partial active area, the voltage is lower because of the higher effective current densities. It is the higher effective reactant flow over the reduced area (and associated higher current density) that improves the performance stability in the low power range.

FIG. 12 shows the impact of decreasing air stoichiometry on voltage stability at a fixed low power current density of 100 mA/cm². Clearly, as the air stoichiometry is decreased below 1.3 the voltage oscillations increase significantly indicating an unstable performance condition. This is often an indication of liquid water blockage in the flow paths (i.e. channel(s)) and/or in the gas diffusion layer (GDL) with insufficient gas flow or pressure drop for water removal. The erratic performance can lead to a low cell condition and in the worst case cell reversal in a fuel cell stack with inherent failure mode issues.

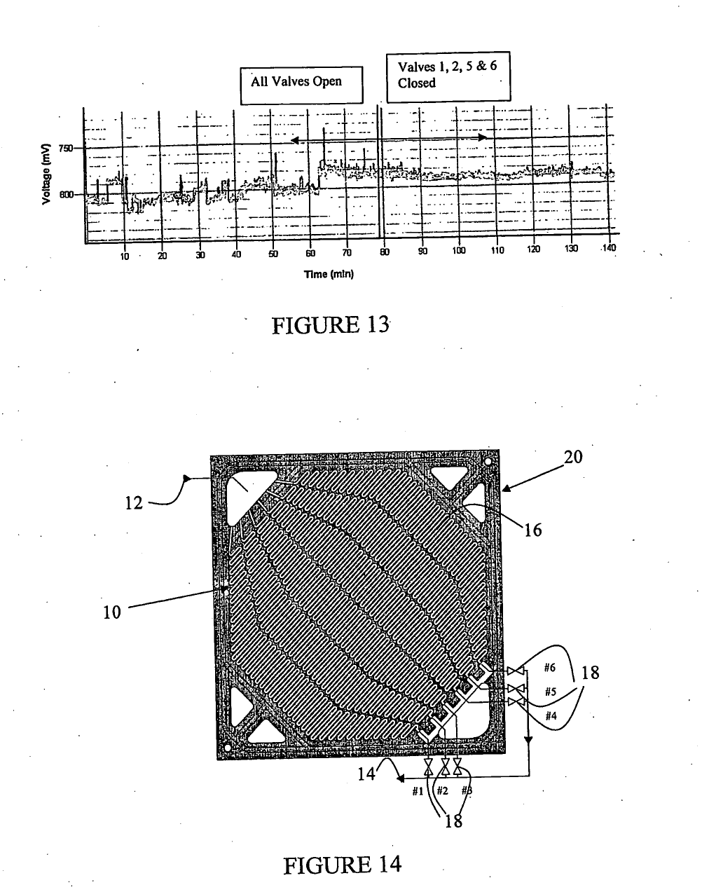

FIG. 13 shows that stable fuel cell performance can be recovered at low power conditions and at low reactant stoichiometry by decreasing the active area of the flow field. In this case a decrease in active area by ˜69% (increases effective current density and reactant flow by ˜323%) stabilized the voltage and removed the large voltage oscillations and spikes (right side of trace). The average voltage performance is lower with the reduced area because of the higher effective current density (compare FIG. 12). In the FIG. 13 example, the fuel cell was initially operating under a load of 80 mA/cm². When four of the valves were closed the current density increased to 254 mA/cm².

As shown in FIG. 3 and as discussed above, reducing the active area in the low power region increases the effective current density (hence lower voltage) and increases the effective reactant flow and associated pressure drop. However, the absolute current and flow do not change from the normal situation for the full active area. Thus, improved fuel cell stack performance stability is achieved without increasing the parasitic load significantly (only a small increase for the increase in pressure drop). In fact, the overall system parasitic load may be significantly reduced because increased absolute reactant flow and purges are not required (i.e. the usage of reactant gases is optimized). The suppressed voltage curve at low current densities may also have benefits in terms of reduced corrosion issues (and other failure modes) and reduced voltage requirements for the power inverter in the system.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A flow field for an apparatus operable in variable operating states, said flow field comprising:
(a) at least one inlet for delivering fluid to said flow field;
(b) at least one outlet for discharging fluid from said flow field;
(c) at least one flow path between said inlet and said outlet; and
(d) at least one adjustable valve for selectively regulating flow of fluid through said flow path in response to changes in said operating states.

2. The flow field as defined in claim 1, comprising a plurality of flow paths between said inlet and said outlet and a plurality of valves for regulating flow of fluid through at least one of said flow paths.

3. (canceled)

4. The flow field as defined in claim 2, wherein said apparatus is a fuel cell.

5. (canceled)

6. (canceled)

7. The flow field as defined in claim 2, wherein adjustment of said valves alters the direction of fluid flow through at least one of said flow paths.

8. (canceled)

9. The flow field as defined in claim 2, wherein said valves are located between said inlet and said outlet.

10. The flow field as defined in claim 2, wherein said valves are located externally of said flow field and are located in fluid communication therewith.

11. The flow field as defined in claim 2, wherein each of said flow paths is separate from one another.

12. The flow field as defined in claim 2, wherein at least some of said flow paths are fluidly coupled together.

13. The flow field as defined in claim 2, wherein said flow paths are parallel.

14. The flow field as defined in claim 2, wherein said flow paths are interdigitated.

15. The flow field as defined in claim 2, wherein said flow paths are serpentine.

16. The flow field as defined in claim 2, wherein said flow paths are branched.

17. The flow field as defined in claim 2, wherein the dimensions of a flow path may vary between said inlet and said outlet.

18. (canceled)

19. The flow field as defined in claim 4, wherein said operating states relate to the power output of said fuel cell.

20. The flow field as defined in claim 4, wherein said operating states relate to the voltage of said fuel cell.

21. The flow field as defined in claim 4, wherein said operating states relate to the temperature of said fuel cell.

22. (canceled)

23. The flow field as defined in claim 2, wherein said valves are adjusted in response to changes in said operating states to maintain a relatively constant pressure drop between said inlet and said outlets.

24. The flow field as defined in claim 2,wherein said valves are microvalves, wherein said microvalves are conductive polymer microvalves which passively respond to changes in voltage with in said flow field.

25. (canceled)

26. (canceled)

27. The flow field as defined in claim 2, wherein said valves are responsive to an electrical signal from said apparatus signaling changes in said operating states.

28. The flow field as defined in claim 2, wherein said valves are configured to maintain a pressure drop between said inlet and said outlets above a threshold value, wherein said threshold value is a pressure sufficient to prevent accumulation of reaction products in said flow field, thereby avoiding the need for periodic purging of said reaction products.

29. (canceled)

30. The flow field as defined in claim 6, wherein said adjustment maintains a current density of said flow field above a threshold amount.

31. A method of regulating flow of fluid in a flow field for an apparatus operable in variable operating states, said flow field having at least one inlet, at least one outlet and at least one flow path between said inlet and said outlet, said method comprising:
(a) determining changes in said operating states; and
(b) selectively regulating the flow of fluid through said flow path in response to said changes in said operating states.

32. The method as defined in claim 31, wherein said flow field comprises a plurality of flow paths between said inlet and said outlet and wherein said regulating comprising regulating fluid flow in at least some of said flow paths.

33. The method as defined in claim 32, wherein said regulating comprises maintaining a current density of said flow field above a threshold amount.

34. The method as defined in claim 32, wherein said regulating comprises maintaining a pressure drop between said inlet and said outlet above a threshold amount, wherein said threshold amopunt is a pressure sufficient to prevent accumulation of fluid reaction products in said flow field.

35. (canceled)

36. (canceled)

37. The method as defined in claim 32, wherein said regulating comprises changing said flow paths within at least of said flow field from one geometry to a different geometry.

38. The method as defined in claim 32, wherein said regulating comprises adjusting the flow rate of said fluid.

39. The method as defined in claim 32, wherein said regulating comprises adjusting the direction of fluid flow through at least some of said flow paths.

40. The method as defined in claim 32, wherein said regulating comprises actively flowing fluid through selected ones of said flow paths to alter the effective active area of said flow field.

41. A fuel cell having a flow field comprising:
(a) an inlet for delivering reactants to said flow field;
(b) an outlet for discharging reaction products from said flow field;
(c) a plurality of flow paths between said inlet and said outlet; and
(d) a plurality of adjustable valves for selectively regulating flow of reactant through said flow paths to alter the active area of said flow field in response to changes in an operating state of said fuel cell.

42. (canceled)

43. (canceled)

44. (canceled)

45. (canceled)

46. (canceled)
